(19) United States
(12) Patent Application Publication
(10) Pub. No.: US 2010/0000471 A1
(43) Pub. Date: Jan. 7, 2010

(54) Retrieval device for creatures

(76) Inventor: Darrell Hibbard, Hamilton (CA)

Correspondence Address: GOWLING, LAFLEUR HENDERSON LLP, ONE MAIN STREET WEST, HAMILTON, ON, L8P 4Z5, CA

(21) Appl. No.: 12/216,512

(22) Filed: Jul. 7, 2008

(51) Int. Cl. A01K 63/02

(52) U.S. Cl. 119/203

(57) ABSTRACT

A retrieval device for retrieving creatures comprises an elongate member having first and second ends in fluid communication via a conduit defined through the elongate member and a capturing element at the first end of the elongate member. The capturing element defines an interior volume, and has an entrance aperture opening into the interior volume and an exit aperture by which the interior volume is in fluid communication with the first end of the elongate member. The capturing element is configured so that when a suitably sized creature is within the interior volume and the retrieval device is oriented with the first end of the elongate member above the second end with the entrance aperture facing generally upward, the capturing element guides the creature under gravity from the interior volume through the exit aperture into the first end of the elongate member and along the conduit to the second end.

### FIELD OF INVENTION

The present invention relates to tools for use with creatures, and more particularly to a device for retrieving creatures.

### BACKGROUND OF THE INVENTION

There are many applications in which it is desirable to retrieve a creature from a particular location. For example, when fishing, minnows and similar live fish may be kept in a water-filled container, such as a bucket or the containers described in U.S. Pat. Nos. 2,560,672 and 3,348,330, and can then be retrieved for installation of a hook. In addition, pet stores often keep fish in aquariums pending sale, at which time the fish must be removed from the aquarium to be given to the purchaser. Additionally, it is also often desirable to collect insects or other creatures.

Various types of devices for retrieving aquatic creatures are known, and include those described in U.S. Pat. Nos. 2,408,306, 3,747,250, 4,034,710, 4,251,938, 4,502,240 and 4,932,150.

### SUMMARY OF THE INVENTION

In one aspect, the present invention is directed to a retrieval device for retrieving creatures. The retrieval device comprises a tube having a first end and a second end, the first end of the tube being in fluid communication with the second end of the tube, and a scoop secured at the first end of the tube. The scoop defines a hollow region and has a mouth permitting entry of a suitably sized creature into the hollow region, and also has an opening permitting passage of the suitably sized creature from the hollow region into the first end of the tube. The scoop is configured so that when the suitably sized creature is within the hollow region and the retrieval device is oriented with the first end of the tube above the second end of the tube with the mouth facing generally upward, the scoop guides the creature to move under gravity from the hollow region into the first end of the tube and along the tube to the second end of the tube.

In one embodiment, the scoop comprises a net.

In one embodiment, the second end of the tube is adapted to permit egress of the creature from the tube. The retrieval device may further comprise a retention arrangement disposed at the second end of the tube.

In one embodiment, the retention arrangement comprises a blocking member movably mounted to the tube so as to be movable between an open position enabling egress of the creature from the second end of the tube and a closed position inhibiting egress of the creature from the second end of the tube, a retaining member movable between a retaining position for retaining the creature adjacent the second end of the tube and a non-retaining position permitting movement of the creature along the tube, and an actuator. The actuator is operable to move the blocking member between the open position and the closed position while moving the retaining member between the retaining position and the non-retaining position, so that when the blocking member is in the open position the retaining member is in the retaining position, and when the blocking member is in the closed position the retaining member is in the non-retaining position.

In a particular embodiment, the blocking member is biased into the open position and the retaining member is biased into the retaining position, and operation of the actuator moves the blocking member into the closed position and moves the retaining member into the non-retaining position. The retention arrangement may further comprise a locking mechanism for locking the blocking member in the closed position.

In another particular embodiment, the blocking member is biased into the closed position and the retaining member is biased into the non-retaining position and operation of the actuator moves the blocking member into the open position and moves the retaining member into the retaining position.

In another embodiment, the retention arrangement comprises a removable cap adapted to fit over the second end of the tube in substantially fluid sealing engagement therewith

In a still further embodiment, the retention arrangement comprises a bag removably secured to the second end of the tube in substantially fluid sealing engagement therewith so that the second end of the tube opens into an interior of the bag.

In yet a further embodiment, the retention arrangement comprises a plurality of retaining members movable between respective retaining positions wherein the retaining members project inwardly into the tube for retaining the creature between the retaining members and adjacent the second end of the tube, and respective non-retaining positions so that movement of the creature along the tube is permitted. The retaining members are biased into the respective non-retaining positions. An actuator may be provided so as to be operable to move the retaining members between the respective retaining positions and the respective non-retaining positions.

In another aspect, the present invention is directed to a retrieval device for retrieving creatures, comprising an elongate member having a first-end and a second end and a conduit defined therethough so that the first end and the second end are in fluid communication and a capturing element secured to the elongate member at the first end thereof. The capturing element defines an interior volume, has an entrance aperture opening into the interior volume, and has an exit aperture by which the interior volume is in fluid communication with the first end of the elongate member. The capturing element is configured so that when a suitably sized creature is within the interior volume and the retrieval device is oriented with the first end of the elongate member above the second end of the elongate member with the entrance aperture facing generally upward, the capturing element guides the creature to move under gravity from the interior volume through the exit aperture into the first end of the elongate member and along the conduit to the second end of the elongate member.

In one embodiment, the capturing element comprises a porous, scoop-shaped net.

In one embodiment, the second end of the elongate member is adapted to permit egress of the creature from the conduit. The retrieval device may further comprise a retention arrangement disposed at the second end of the elongate member.

In one embodiment, the retention arrangement comprises a blocking member movably mounted to the elongate member so as to be movable between an open position enabling egress of the creature from the conduit via the second end of the elongate member and a closed position inhibiting egress of the creature from the conduit via the second end of the elongate member, a retaining member movable between a retaining position for retaining the creature in the conduit adjacent the second end of the elongate member and a non-retaining position permitting movement of the creature along the conduit, and an actuator. The actuator is operable to move the blocking member between the open position and the closed position while moving the retaining member between the retaining position and the non-retaining position, so that when the blocking member is in the open position the retaining member is in the retaining position, and when the blocking member is in the closed position the retaining member is in the non-retaining position.

In a particular embodiment, the blocking member is biased into the open position and the retaining member is biased into the retaining position, and operation of the actuator moves the blocking member into the closed position and moves the retaining member into the non-retaining position. The retention arrangement may further comprise a locking mechanism for locking the blocking member in the closed position.

In another particular embodiment, the blocking member is biased into the closed position and the retaining member is biased into the non-retaining position and operation of the actuator moves the blocking member into the open position and moves the retaining member into the retaining position.

In another embodiment, the retention arrangement comprises a removable cap adapted to fit over the second end of the elongate member in substantially fluid sealing engagement therewith.

In a still further embodiment, the retention arrangement comprises a bag removably secured to the second end of the elongate member in substantially fluid sealing engagement therewith so that the second end of the elongate member opens into an interior of the bag.

In yet a further embodiment, the retention arrangement comprises a plurality of retaining members movable between respective retaining positions wherein the retaining members project through the elongate member and inwardly into the conduit for retaining the creature between the retaining members and adjacent the second end of the elongate member, and respective non-retaining positions so that movement of the creature along the conduit is permitted. The retaining members are biased into the respective non-retaining positions. An actuator may be provided so as to be operable to move the retaining members between the respective retaining positions and the respective non-retaining positions.

### BRIEF DESCRIPTION OF THE DRAWINGS

These and other features of the invention will become more apparent from the following description in which reference is made to the appended drawings wherein:

FIG. 1A shows an embodiment of a retrieval device for retrieving creatures in accordance with an embodiment of an aspect of the present invention;

FIG. 1B shows the retrieval device of FIG. 1A, fitted with a first embodiment of a retention arrangement;

FIG. 2 shows a side view of the first embodiment of the retention arrangement, along with a portion of the retrieval device of FIG. 1B;

FIG. 3 shows a side view of the first embodiment of the retention arrangement, along with a portion of the retrieval device of FIG. 1B, with a cap fitted over an end of the retrieval device;

FIG. 4 shows a side cross-sectional view of the first embodiment of the retention arrangement in a first position, along with a portion of the retrieval device of FIG. 1B;

FIG. 5 shows a side cross-sectional view of the first embodiment of the retention arrangement in a second position, along with a portion of the retrieval device of FIG. 1B;

FIG. 6 shows a side cross-sectional view of the first embodiment of the retention arrangement in a first position, along with a portion of the embodiment of FIG. 1B, and illustrates installation of a hook in an aquatic creature when the first embodiment of the retention arrangement is in the second position;

FIG. 7 shows a side cross-sectional view of the first embodiment of the retention arrangement along with a portion of the embodiment of FIG. 1B, and illustrates removal of an aquatic creature following installation of a hook therein;

FIG. 8 is a side cross-sectional view of a second embodiment of a retention arrangement in a first position;

FIG. 9 is a side cross-sectional view of the second embodiment of a retention arrangement in a second position;

FIG. 10 shows the retrieval device of FIG. 1A, fitted with a third embodiment of a retention arrangement;

FIG. 11 shows the retrieval device of FIG. 1A, fitted with a fourth embodiment of a retention arrangement;

FIG. 12A shows the retrieval device of FIG. 1A, fitted with a fifth embodiment of a retention arrangement;

FIG. 12B is a partial cross-sectional view taken along the line 12B-12B in FIG. 14;

FIG. 13 is a partial cross-sectional view taken along the line 12B-12B in FIG. 14 and showing an aquatic creature disposed therein;

FIG. 14 is an end view of a portion of the retrieval device of FIG. 1A fitted with the fifth embodiment of a retention arrangement, with the retention arrangement in a first position;

FIG. 15 is a partial cross-sectional view taken along the line 15-15 in FIG. 16 and showing an aquatic creature disposed therein;

FIG. 16 is an end view of a portion of the retrieval device of FIG. 1A fitted with the fifth embodiment of a retention arrangement, with the retention arrangement in a second position;

FIG. 17 is an end view of a portion of the retrieval device of FIG. 1A fitted with a sixth embodiment of a retention arrangement;

FIG. 18 is a side view of a seventh embodiment of a retention arrangement in a first position; and

FIG. 19 is a side view of the seventh embodiment of a retention arrangement in a second position.

### DETAILED DESCRIPTION

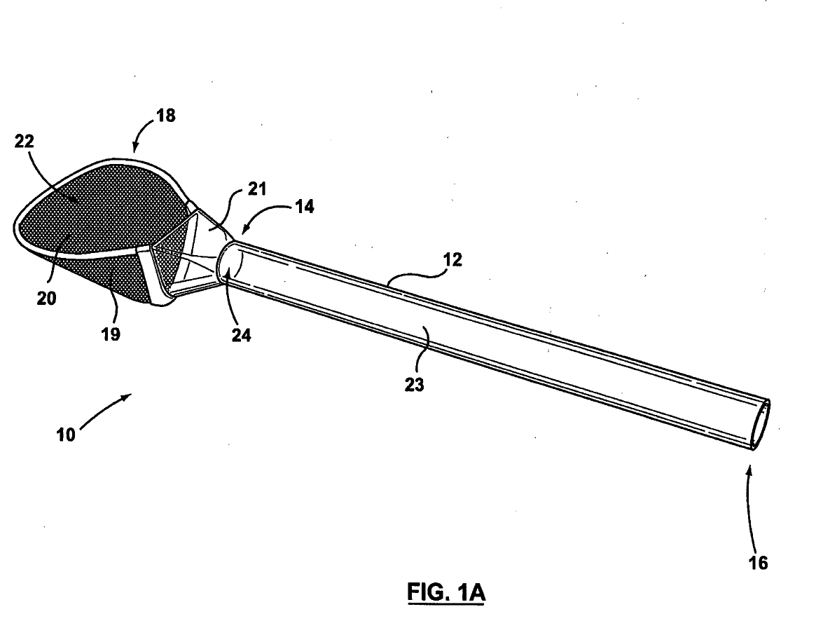

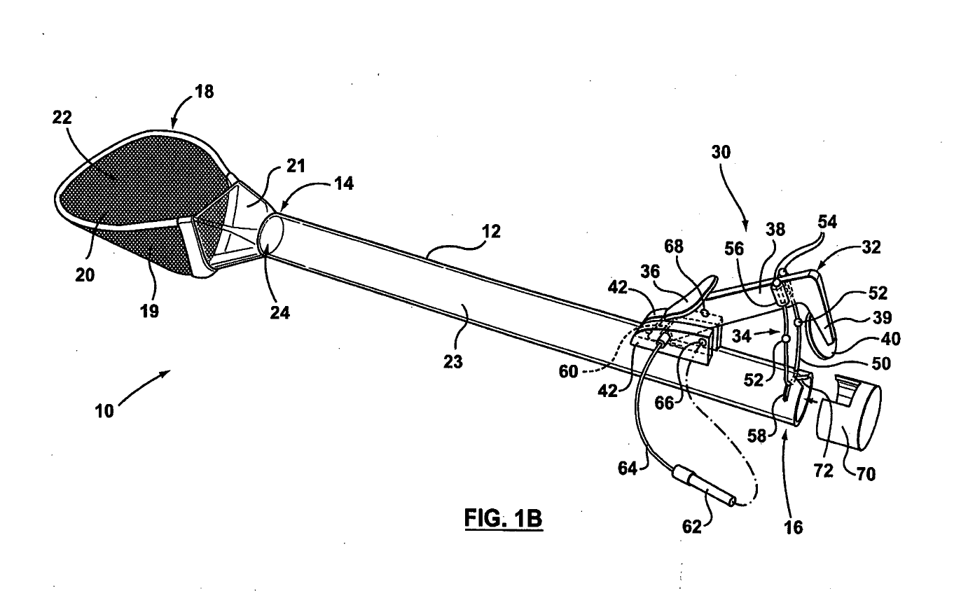

With reference now to FIG. 1A, an exemplary embodiment of a retrieval device for retrieving creatures according to an aspect of the present invention is shown generally at 10. A retrieval device according to an aspect of the present invention comprises an elongate member 12 having a first end 14 and a second end 16 and a conduit 23 defined therethrough so that the first end 14 and the second end 16 are in fluid communication with one another. In the embodiment shown in FIG. 1A, the elongate member 12 is a cylindrical tube.

A retrieval device according to an aspect of the present invention further comprises a capturing element 18 secured to the elongate member 12 at the first end 14 thereof, with the capturing element 18 defining an interior volume 20 and having an entrance aperture 22 opening into the interior volume 20 as well as an exit aperture 24 by which the interior volume 20 is in fluid communication with the first end 14 of the elongate member 12. In the particular embodiment 10 shown in FIG. 1A, the capturing element 18 comprises a scoop 19 formed from a porous netting, with the interior volume 20 being a hollow region 20 defined by the scoop 19, and the entrance aperture 22 is the mouth 22 of the scoop 18, which permits entry of a suitably sized creature (not shown in FIG. 1A) into the hollow region 20. Still referring to the particular embodiment 10 shown in FIG. 1A, the scoop 19 has an opening, comprising the fluid communication path along a passage through the funneling region 21 into the exit aperture 24, which permits passage of a suitably sized creature from the hollow region 20 into the first end 14 of the elongate member 12.

As can be seen by reference to FIG. 1A, that when a suitably sized creature (not shown in FIG. 1A) is within the interior volume 20 of the capturing element 18 and the retrieval device 10 is oriented with the first end 14 of the elongate member 12 above the second end 16 of the elongate member 12 with the entrance aperture 22 facing generally upward, the creature is guided by the configuration of the capturing element 18 to move under gravity from the interior volume 20 through the exit aperture 24 into the first end 14 of the elongate member 12 and along the conduit 23 to the second end 16 of the elongate member. The term “generally upward”, as used in reference to the entrance aperture 22, means that the capturing element is oriented in such a way that the creature will not fall, under gravity, out of the entrance aperture 22. The capturing element 18 is configured so that when the retrieval device 10 is oriented as described above, the combination of shape and material used for the capturing element 18 will guide the creature to move, under the influence of gravity, from the interior volume 20 through the exit aperture 24 into the first end 14 of the elongate member 12. In the case of net 19, it can be seen that the scoop shape of the net 19 guides the creature into and through the funnel region 21 and then into the conduit 23. Where a net is used, the pore size for the net should be selected to inhibit appendages of the creature from becoming entangled in the pores.

A retrieval device according to an aspect of the present invention may further comprise a retention arrangement disposed at the second end 16 of the elongate member 12. In certain embodiments, the retention arrangement will comprise a blocking member, a retaining member, and an actuator. In such embodiments, the blocking member is movably mounted to the elongate member 12 so as to be movable between an open position enabling egress of the creature from the conduit 23 at the second end 16 of the elongate member 12 and a closed position inhibiting egress of the creature from the conduit 23 at the second end 16 of the elongate member 12, and the retaining member is movable between a retaining position for retaining the creature in the conduit 23 adjacent the second end 16 of the elongate member 12 and a non-retaining position permitting movement of the creature within the conduit 23. The actuator is operable to move the blocking member between the open position and the closed position while moving the retaining member between the retaining position and the non-retaining position. As will be illustrated and explained below, in certain preferred embodiments the actuator, blocking member and retaining member are configured to mechanically cooperate with one another so that when the blocking member is in the open position, the retaining member is in the retaining position, and when the blocking member is in the closed position the retaining member is in the non-retaining position.

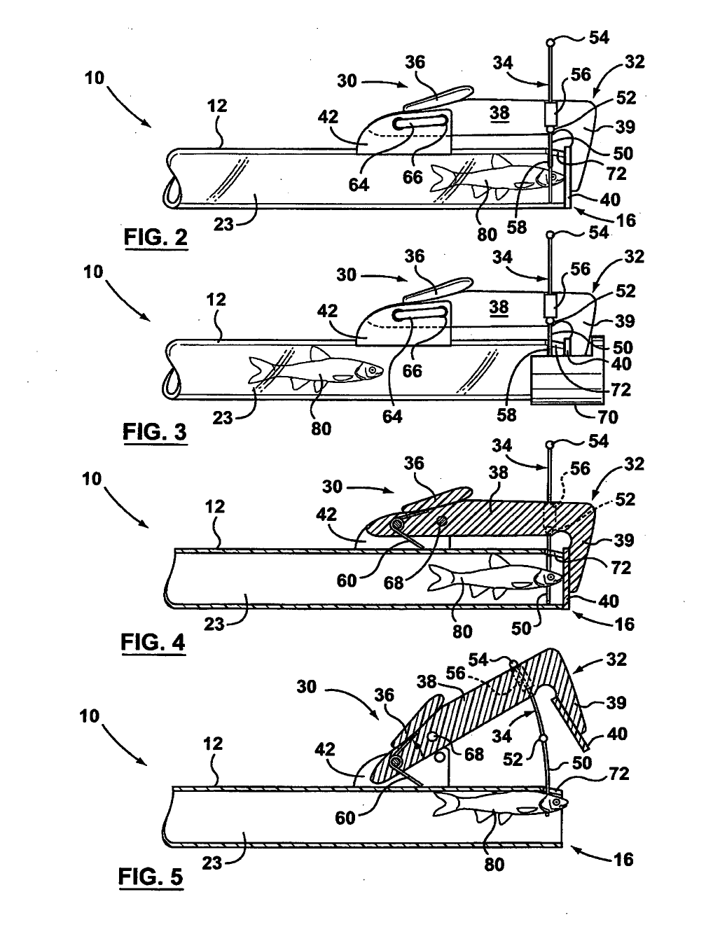

Referring now to FIG. 1B, and with further reference to FIGS. 2 to 5, an exemplary embodiment of such a retention arrangement is denoted by the reference numeral 30. In the exemplary retention arrangement 30, the blocking member comprises a generally L-shaped arm 32, the retaining member comprises a cord 34, and the actuator comprises a thumb-pad 36.

The L-shaped arm 32 comprises an actuating portion 38 and a blocking portion 39 terminating in a circular obstruction member 40 sized to obstruct egress of a creature from the conduit 23 at the second end 16 of the elongate member 12 when positioned in front thereof. The cord 34 is formed into a loop 50, which passes through a set of notches 58 at the second end 16 of the elongate member 12. The looped cord 34 has a first set of stops 52 symmetrically disposed at an intermediate position at each side of the loop 50 formed by the cord 34 and a second set of stops 54 disposed at or immediately adjacent the ends of the cord 34. The portions of the cord 34 between the first set of stops 52 and the second set of stops 54 are slidably received by receivers 56 on the actuating portion 38 of the L-shaped arm 32, so that sliding movement of the cord 34 relative to the L-shaped arm 32 is constrained by the stops 52, 54.

The end of the actuating portion 38 of the L-shaped arm 32 that is remote from the blocking portion 39 is pivotally mounted to the elongate member 12 by way of brackets 42, and the thumb-pad 36 is attached to the actuating portion 38 so that pushing on the thumb pad 36 causes the L-shaped arm 32 to pivot toward the elongate member 12. A spring 60 (best seen in FIGS. 4 and 5) biases the L-shaped arm 32 to pivot away from the elongate member 12 until further pivotal movement of L-shaped arm 32 is arrested by the looped cord 34, because the cord 34 is looped through the notches 58 in the elongate member 12 and the second set of stops 54 prevents further relative sliding movement of the receivers 56 and the cord 34. The position at which further pivotal movement of the L-shaped arm is arrested by the cord 34 defines both the open position for the blocking member comprising the L-shaped arm 32 as well as the retaining position for the retaining member comprising the cord 34 (as will be explained in greater detail below), so that the spring 60 has the effect of simultaneously biasing the blocking member comprising the L-shaped arm 32 into the open position and biasing the retaining member comprising the cord 34 into the retaining position. As will also be described further below, operation of the actuator (i.e. applying pressure to the thumb-pad 36 to overcome the biasing effect of the spring 60) moves the blocking member comprising the L-shaped arm 32 into the closed position and moves the retaining member comprising the cord 34 into the non-retaining position. A recess 72 is provided at the second end 16 of the elongate member 12.

For transport and storage of a retrieval device according to an aspect of the present invention, the retention arrangement may be provided with a locking mechanism to lock the retention arrangement in a particular position. The retention arrangement 30 shown in FIGS. 1 to 5 includes a locking pin 62 attached to one of the brackets 42 by way of a flexible connector 64. When the blocking member comprising the L-shaped arm 32 is in the closed position, an aperture 66 in one of the brackets 42 will be aligned with a corresponding aperture 68 in the actuating portion 38 of the L-shaped arm 32, so that the locking pin 62 can pass through both apertures 66, 68 and thereby secure the blocking member comprising the L-shaped arm 32 in the closed position, as shown in FIG. 2. Preferably, the locking pin 62 will have a friction fit with one or both apertures 66, 68 to retain the locking pin 62 within the apertures.

Additionally or alternatively to the locking pin 62, a cap 70 may be provided, which cap 70 is adapted to fit over the second end 16 of the elongate member 12, and also over the obstructing member 40, when the blocking member comprising the L-shaped arm 32 is in the closed position. This arrangement prevents pivotal movement of the blocking member comprising the L-shaped arm 32 away from the elongate member 12 under urging from the spring 60, and thereby retains the blocking member comprising the L-shaped arm 32 in the closed position, as shown in FIG. 3. Preferably, the cap 70 is adapted to friction fit over the second end 16 of the elongate member 12, and may be fitted with an o-ring or other seal to inhibit fluid leakage.

With reference now to FIGS. 4 and 5, operation of the exemplary retention arrangement 30 is now described.

As shown in FIG. 4, a creature, in this particular instance an aquatic creature, namely minnow 80, is disposed inside the elongate member 12 adjacent the second end 16 thereof, having traveled through the entrance aperture 22 of the capturing element 18, through the interior volume 20, through the exit aperture 24 into the first end 14 of the elongate member 12 and then along the conduit 23 (all shown in FIG. 1B). The blocking member comprising the L-shaped arm 32 is in the closed position, with the obstruction member 40 inhibiting egress of the minnow 80 from the conduit 23 at the second end 16 of the elongate member 12, and the retaining member comprising the cord 34 is in the non-retaining position with the loop 50 formed by the cord 34 positioned adjacent the walls of the conduit 23 and encircling the region of the minnow 80 to the immediate posterior of the minnow's head. The loop 50 formed by the cord 34 is maintained in this position by the pressure exerted by the receivers 56 on the first set of stops 52. The blocking member comprising the L-shaped arm 32 may be maintained in the closed position, thereby maintaining the retaining member comprising the cord 34 in the non-retaining position, by operation of the actuator (i.e. by application of pressure on the thumb-pad 36).

Removing pressure from the thumb-pad 36 causes the blocking member comprising the L-shaped arm 32 to pivot, under urging from the spring 60, away from the elongate member 12 and into the open position, as shown in FIG. 5. The pivotal movement of the L-shaped arm 32 away from the elongate member 12 causes the receivers 56 to slide along the cord 34 until the receivers 56 come in contact with the second set of stops 54 on the cord 34, after which continued pivotal movement of the L-shaped arm 32, by way of the force exerted by the receivers 56 on the second set of stops 54, pulls the retaining member comprising the cord 34 into the retaining position shown in FIG. 5. In the process of moving from the non-retaining position (FIG. 4) to the retaining position shown in FIG. 5, the retaining member comprising the cord 34 captures and retains the minnow 80. In particular, because the loop 50 formed by the cord 34 encircles the minnow 80, movement of the retaining member comprising the cord 34 from the non-retaining position (FIG. 4) to the retaining position (FIG. 5) will, when made with sufficient speed, cause the minnow to be ensnared and retained between the loop 50 formed by the cord 34 and the interior surface of the conduit 23 inside the elongate member 12, with the head of the minnow 80 exposed at the second end 16 of the elongate member 12.

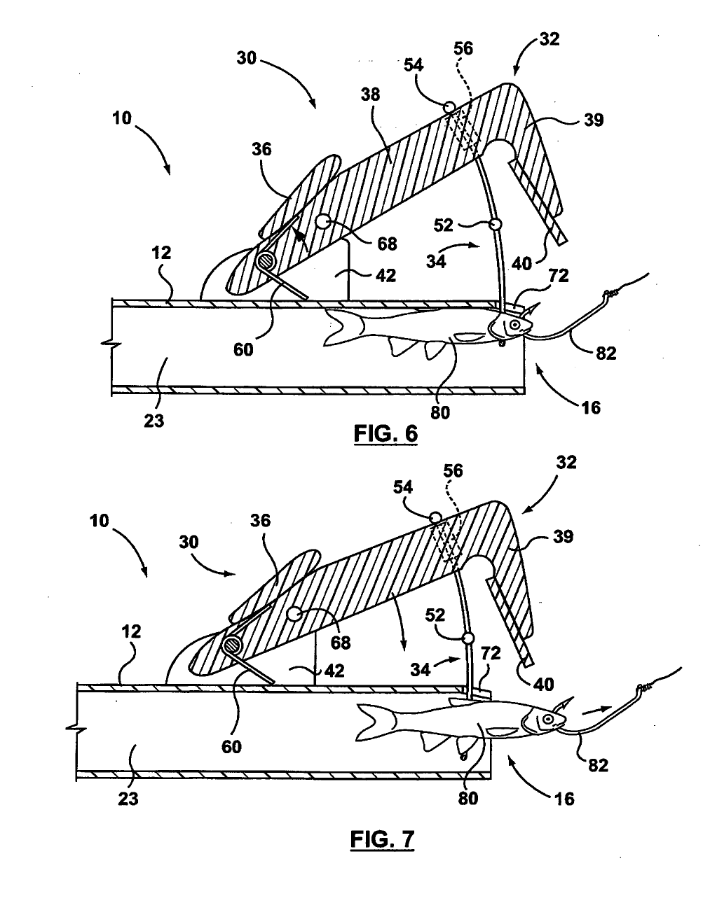

With the head of the minnow 80 exposed at the second end 16 of the elongate member 12 and the minnow firmly retained (under the force of the spring 60) by the retaining member comprising the cord 34, a hook 82 can be installed in the minnow 80, as shown in FIG. 6. Installing the hook 82 is facilitated by the recess 72 at the second end 16 of the elongate member 12. Once the hook 82 has been installed, the actuator can be operated (i.e. pressure can be applied to the thumb-pad 36) so as to move the blocking member comprising the L-shaped arm 32 to a position intermediate the open position and the closed position, as shown in FIG. 7, thereby creating sufficient slack in the loop 50 formed by the cord 34 to enable the minnow 80 to be withdrawn while still leaving the second end 16 of the elongate member 12 substantially unobstructed by the obstructing member 40.

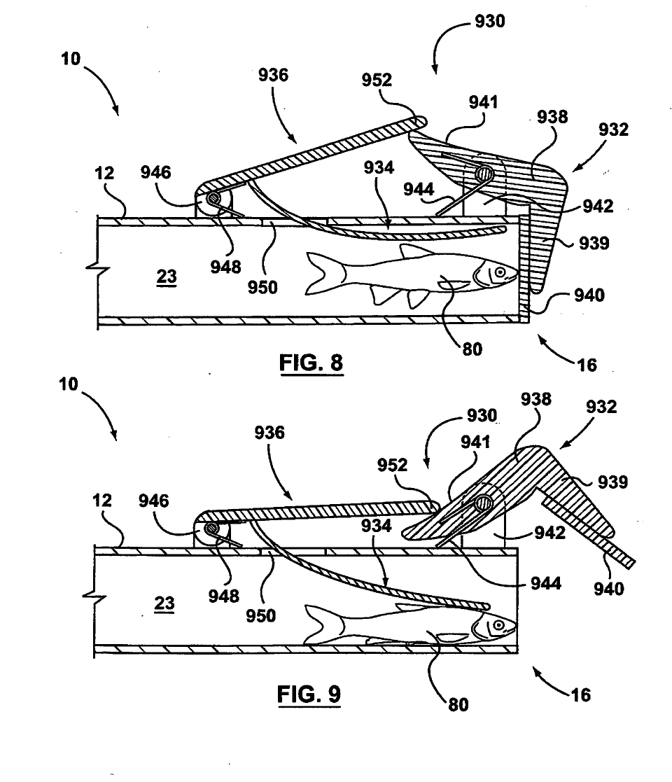

With reference now to FIGS. 8 and 9, an alternative embodiment of a retention arrangement for use with a retrieval device (such as the retrieval device 10) is indicated generally by the reference numeral 930. In the retention arrangement 930 shown in FIGS. 8 and 9, the blocking member is biased into the closed position and the retaining member is biased into the non-retaining position, and operation of the actuator moves the blocking member into the open position and moves the retaining member into the retaining position.

In the exemplary retention arrangement 930, the blocking member comprises a generally L-shaped arm 932, the retaining member comprises a curved retaining member 934, and the actuator comprises a lever member 936.

The L-shaped arm 932 comprises an actuating portion 938 and a blocking portion 939 terminating in a circular obstruction member 940 sized to obstruct egress of a creature from the second end 16 of the elongate member 12 when positioned in front thereof. The L-shaped arm 932 is pivotally mounted to the second end 16 of the elongate member 12 by way of a blocking member bracket 942, and is biased into the closed position, as shown in FIG. 8, by a blocking member spring 944. A cam surface 941 is provided on the actuating portion 938 of the L-shaped arm 932.

The lever member 936 is pivotally mounted to the second end 16 of the elongate member 12 by way of a lever member bracket 946, at a position closer to the first end 14 of the elongate member 12 than the L-shaped arm 932. The lever member 936 is biased away from the elongate member 12 by a lever member spring 948.

The retaining member 934 projects from the underside of the lever member 936 adjacent the lever member bracket 946, and extends into the conduit 23 through a slot 950 in the elongate member 12, continuing toward the second end 16 of the elongate member 12. Because the retaining member 934 is secured to the lever member 936, which is biased away from the elongate member 12, the retaining member 934 is also biased by the lever member spring 948 into the non-retaining position, as shown in FIG. 8. Optionally, the lever member spring 948 may be omitted, and the lever member 936 and retaining member 938 may be indirectly biased by the blocking member spring 944, via contact between the L-shaped arm 932 and underside of the lever member 936 at the tip 952 thereof.

Accordingly, the blocking member comprising the L-shaped arm 932 is biased into the closed position and the retaining member 934 is biased into the non-retaining position. Operation of the actuator comprising the lever member 936 will, as described in greater detail below, move the blocking member comprising the L-shaped arm 932 into the open position and move the retaining member 934 into the retaining position.

In operation, when a creature, such as a minnow 80, has entered the conduit 23 and moved toward the second end 16 of the elongate member 12, a user would apply downward force (for example with his or her thumb) to the lever member 936. Where such force is sufficient to overcome the biasing forces exerted by the lever member spring 948 (if present) and the blocking member spring 944, the lever member 936 will pivot toward the elongate member 12 and the tip 952 of the lever member 936 will cam against the cam surface 941 on the L-shaped arm 932. This action causes the L-shaped arm 932 to pivot so the blocking portion 939 moves away from the second end 16 of the elongate member 12, thereby moving the blocking member comprising the L-shaped arm 932 into the open position shown in FIG. 9, with the obstructing member 940 clear of the second end 16 of the elongate member 12 to permit egress from the conduit 23. Simultaneously, the pivotal movement of the lever member 936 toward the elongate member 12 causes downward movement of the retaining member 934 into the retaining position shown in FIG. 9, so that the retaining member 934 contacts and applies pressure to the minnow 80, thereby trapping and retaining the minnow 80 between the retaining member 934 and the interior surface of the elongate member 12. A hook can then be installed in the minnow 80, and a slight reduction in the pressure applied to the lever member 936 will enable the minnow 80 to be withdrawn from the conduit 23. Preferably, the retaining member 934 is made from a flexible or resilient material so as to limit undesirable injury to a creature (such as the minnow 80) when the retaining member 934 is moved into the retaining position, and to reduce the likelihood of breakage of the retaining member 934.

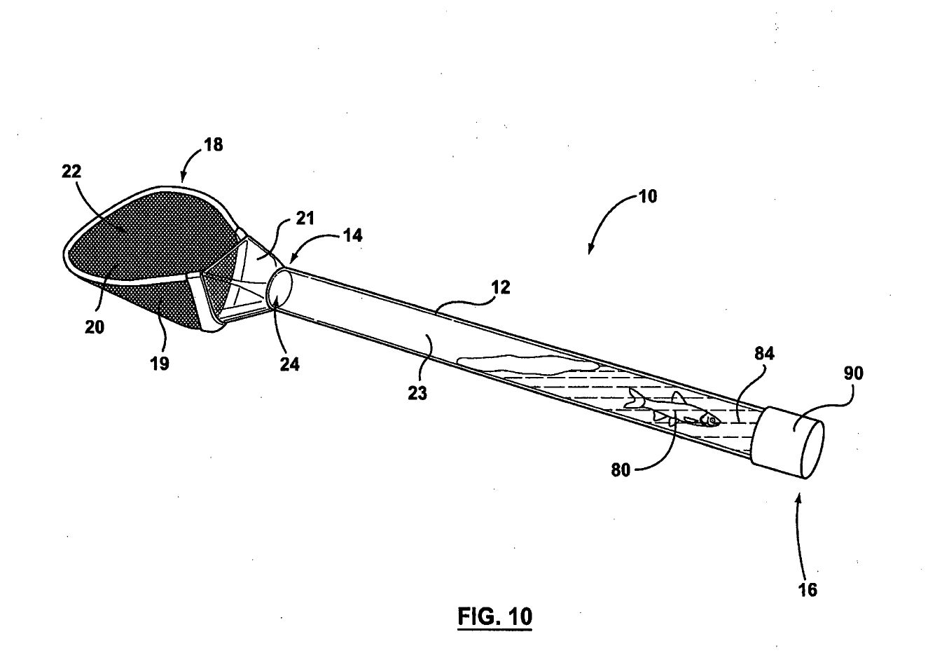

With reference now to FIG. 10, the retrieval device 10 according to an aspect of the present invention is shown with a further alternative embodiment of a retention arrangement. The retention arrangement comprises a removable cap 90 adapted to fit over the second end 16 of the elongate member 12 in substantially fluid sealing engagement therewith, for example by way of an interference fit. When the cap 90 is secured over the second end 16 of the elongate member 12, an aquatic creature, such as minnow 80, along with a volume of water 84, may be retained within the conduit 23 when the retrieval device is oriented so that the first end 14 of the elongate member 12 is above the second end 16 thereof. Removal of the removable cap 90 enables the aquatic creature (minnow 80 in FIG. 10) to exit the conduit 23 by way of the second end 16 of the elongate member 12. A retention arrangement such as that comprising removable cap 90 may be useful in situations where it is desired to transfer an aquatic creature from a first receptacle (such as a main aquarium) to a nearby second receptacle (such as an auxiliary aquarium). As such, the cap 90 may be provided with an o-ring or similar seal to inhibit fluid leakage. The retention arrangement shown in FIG. 10 may also be used with non-aquatic creatures.

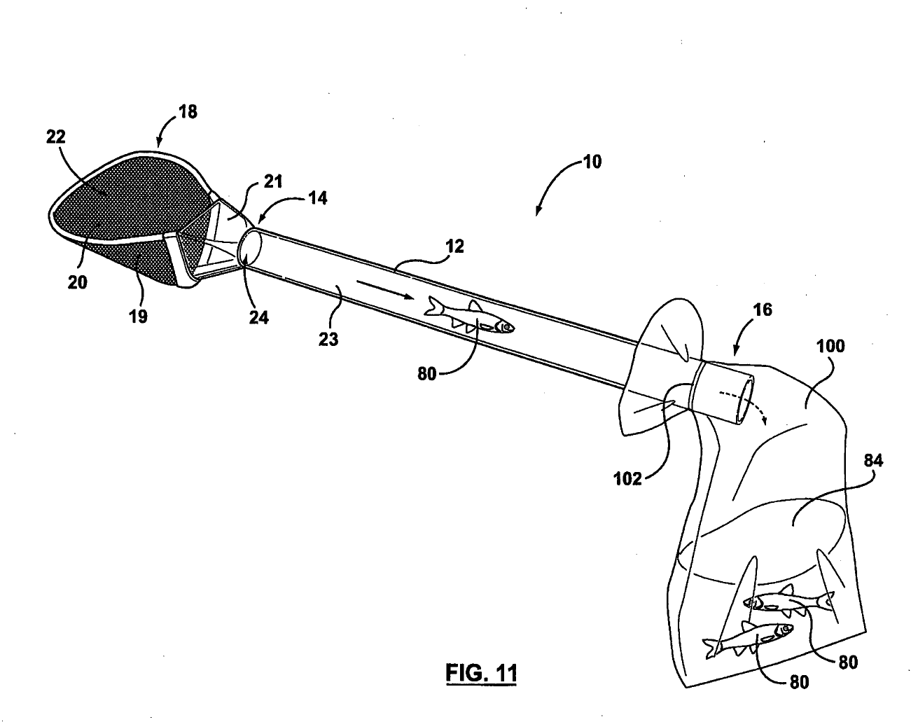

With reference now to FIG. 11, the retrieval device 10 according to an aspect of the present invention is shown with a still further alternative embodiment of a retention arrangement In the embodiment shown in FIG. 11, the retention arrangement comprises a bag 100 removably secured to the second end 16 the elongate member 12 in substantially fluid sealing engagement therewith so that the second end 16 of the elongate member 12 opens into the interior of the bag 100. The bag 100 may be a transparent or translucent flexible plastic bag of the type typically used by pet stores to provide fish to customers, and may be secured to the elongate member, for example, by way of elastic 102.

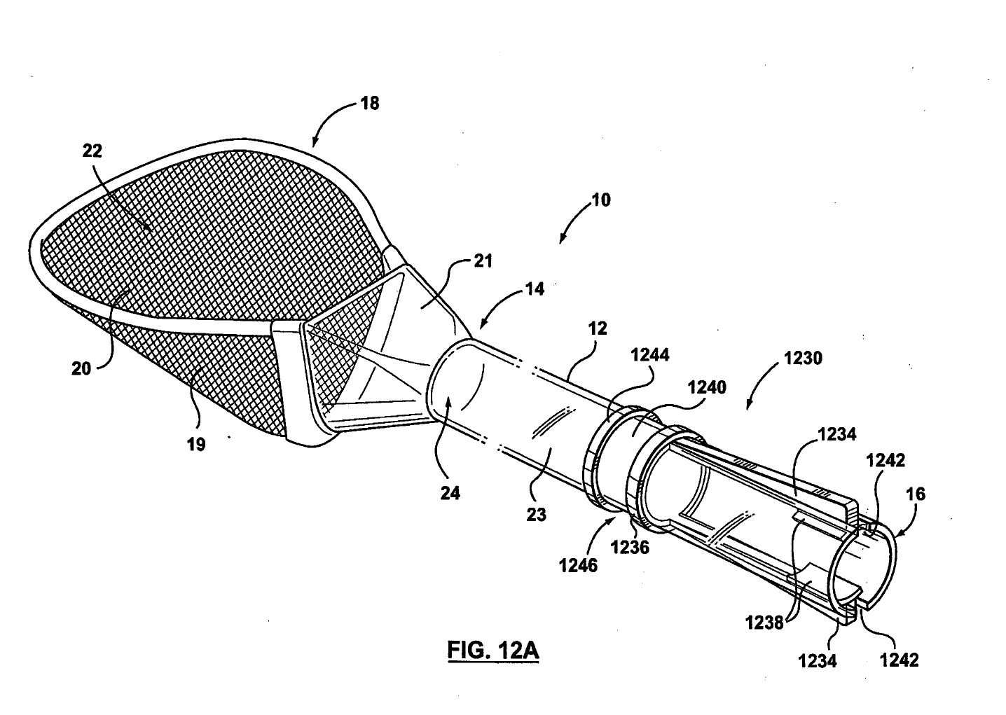

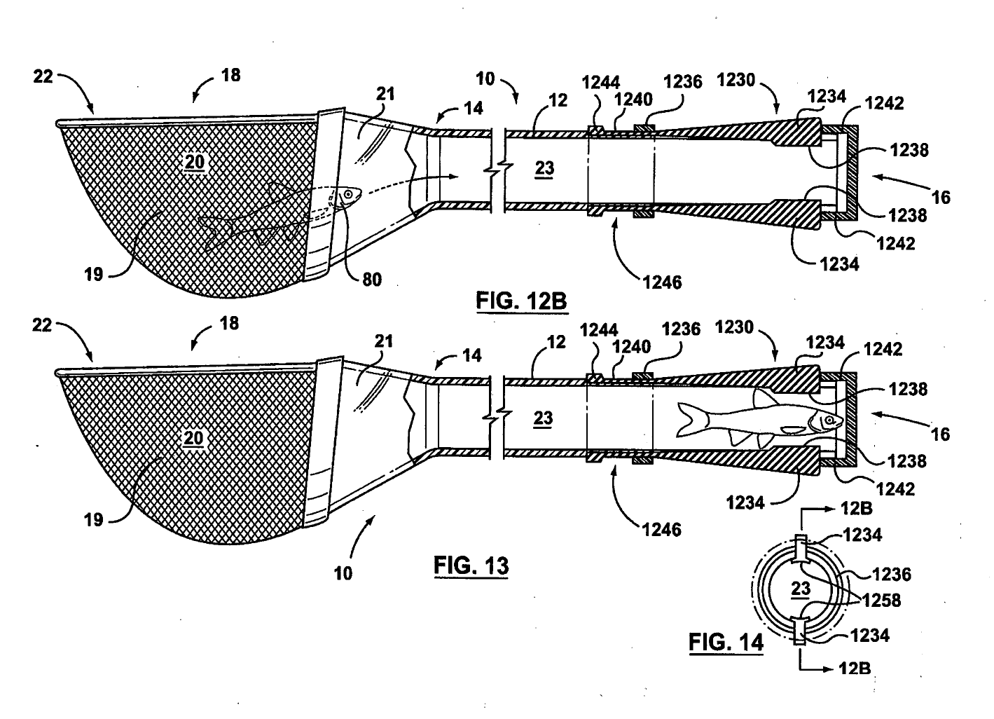

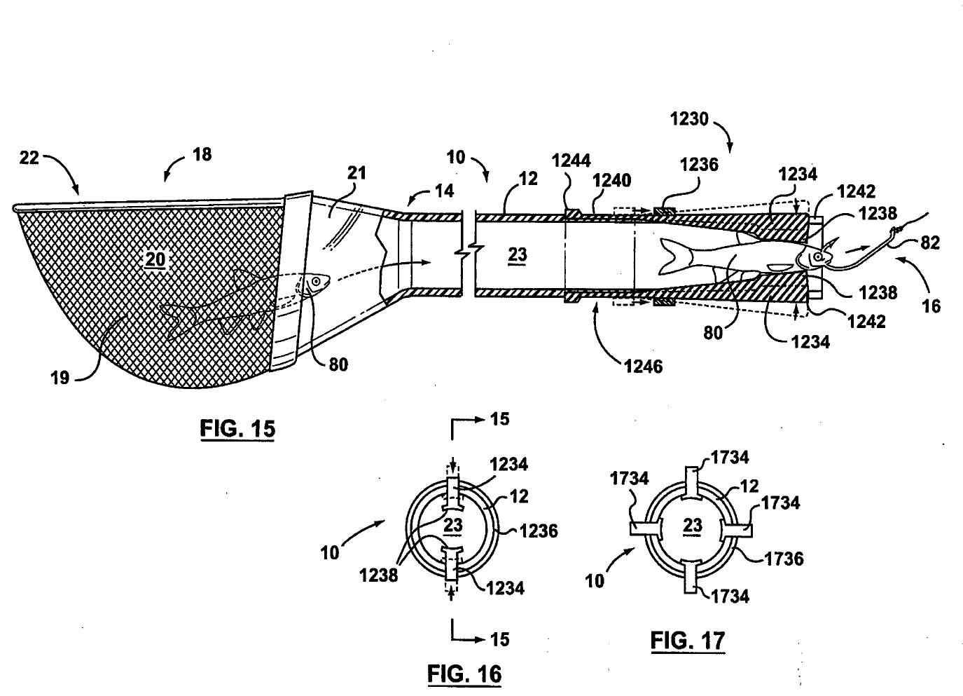

Now referring to FIGS. 12A to 16, the retrieval device 10 according to an aspect of the present invention is illustrated with yet a further embodiment of a retention arrangement indicated generally by the reference numeral 1230. The retention arrangement 1230 comprises a plurality of retaining members 1234, with each retaining member 1234 being movable between a respective retaining position, as shown in FIGS. 15 and 16, and a respective non-retaining position, as shown in FIGS. 12A to 14. In the particular embodiment shown in FIGS. 12A to 16, the retaining members 1234 comprise two opposed, wedge shaped splines, and have clamping pads 1238 disposed on the inner edges thereof (i.e. on the edges facing inwardly relative to the elongate member 12). The clamping pads may be integrally formed with the retaining members 1234, or else may be formed separately and secured thereto.

The retaining members 1234 are received within slots 1242 in the elongate member 12, and are retained within the slots 1242 by the clamping pads 1238, which have a width greater than the width of the slots 1242.

The retaining members 1234 are secured to the elongate member 12 byway of a securing ring 1240, which is securely received, for example by way of adhesive or a friction fit, within a depression (indicated generally at reference numeral 1246) on the outer surface of the elongate member 12. Preferably, the retaining members 1234 are integrally formed with the securing ring 1240, and the retaining members 1234 and securing ring 1240 are formed from a resilient material having sufficient flexibility to permit the retaining members 1234 to pivot relative to the securing ring. However, other suitable techniques for affixing the retaining members 1234 to the securing ring 1240 may also be used. By way of example only, in an alternative embodiment (not shown) the retaining members could be formed from a rigid material, and mounted to the securing ring by way of a pivot pin and spring arrangement, with the spring biasing the retaining members away from the elongate member 12.

An actuator 1236 in the form of an actuator ring is slidably received over the outside surface of the elongate member 12 and over the securing ring 1240 so as to be axially slidable along the outside of the elongate member 12. Axial movement of the actuator 1236 toward the first end 14 of the elongate member 12 is limited by a stop 1244, which in the embodiment shown is integrally formed with the securing ring 1240. The stop 1244 may alternatively be a separate piece secured in place, for example, by way of a friction fit or by adhesive. As can be seen in FIGS. 12A through 16, the actuator 1236 is operable to move the retaining members 1234 between their respective retaining positions and their respective non-retaining positions. In particular, sliding the actuator 1236 along the exterior surface of the elongate member 12 toward the second end 16 thereof forces the retaining members 1234 through the slots 1242 and into the conduit 23, and sliding the actuator 1236 away from the second end 16 of the elongate member 12 releases the retaining members 1234.

Referring specifically now to FIGS. 13 and 14, when the actuator 1236 is positioned adjacent the bases of the retaining members 1234, the retaining members 1234 are in the non-retaining position, so that a creature, illustrated as minnow 80, may move freely within the conduit 23. The retaining members 1234 are biased into the non-retaining position, preferably by being integrally formed with the securing ring 1240 in such a shape that when the securing ring 1240 is secured to the elongate member 12, the retaining members will naturally adopt the non-securing position.

Now referring to FIGS. 15 and 16, when the actuator 1236 is moved toward the second end 16 of the elongate member 12, it will slide along the outer edges of the retaining members 1234 and, since the retaining members 1234 are (in the embodiment shown) integrally formed with the securing ring 1240 and composed of a resilient material, such movement of the actuator 1236 will force the retaining members 1234 through the slots 1242 in the elongate member 12 and inwardly into the conduit 23 for retaining the creature (minnow 80) between the retaining members 1234, adjacent the second end 16 of the elongate member 12. In particular, the creature (minnow 80) will be retained between the clamping pads 1238, enabling installation of a hook 82.

It is to be appreciated that while the embodiment illustrated in FIGS. 12A to 16 has two opposed retaining members 1234, embodiments based on a similar design may have more than two retaining members. By way of non-limiting example, FIG. 17 shows an alternative embodiment having four retaining members 1734 movable by way of an actuator 1736 slidably received on the elongate member 12 in a manner analogous to that described in respect of FIGS. 12A to 16, between a retaining position wherein the retaining members 1734 project inwardly through slots in the elongate member 12 into the conduit 23 for retaining the creature, and a non-retaining position whereby a creature can move freely within the conduit 23.

It should also be appreciated that while the embodiments described in the context of FIGS. 12A to 17 include an actuator in the form of actuator ring 1236, 1736, such an actuator may optionally be omitted. For example, for the embodiment shown in FIGS. 12A to 16, if the actuator ring 1236 were omitted, the retaining members 1234 could be moved into the retaining position by applying hand pressure (e.g. by thumb and forefinger) directly to the retaining members 1234.

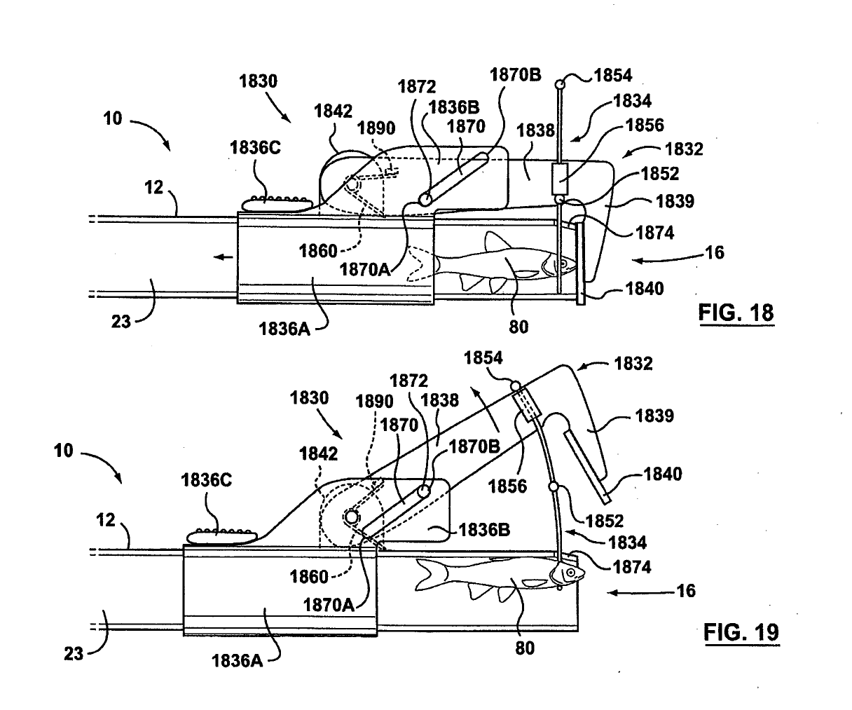

With reference now to FIGS. 18 and 19, a further alternative embodiment of a retention arrangement for retrieval device 10 is illustrated generally at 1830. The retention arrangement 1830 embodies design principles similar to those of the retention arrangement 30 described in the context of FIGS. 2 through 7, and comprises a blocking member, a retaining member, and an actuator. The blocking member is movably mounted to the elongate member 12 so as to be movable between an open position enabling egress of a suitably sized creature from the second end 16 of the elongate member 12, and a closed position inhibiting egress of the creature from the second end 16 of the elongate member 12. The retaining member is movable between a retaining position for retaining the creature adjacent the second end 16 of the elongate member 12, and a non-retaining position permitting movement of the creature along the conduit 23 defined by the elongate member 12. The actuator is operable to move the blocking member between the open position and the closed position while moving the retaining member between the retaining position and the non-retaining position, so that when the blocking member is in the open position the retaining member is in the retaining position, and when the blocking member is in the closed position the retaining member is in the non-retaining position.

In the embodiment shown in FIGS. 18 and 19, the blocking member comprises a generally L-shaped arm 1832, the retaining member comprises a cord 1834, and the actuator comprises an actuator slider 1836A that is slidably received over the outer surface of the elongate member 12, an actuator member 1836B extending from the actuator slider 1836A, and a thumb-pad 1836C on the actuator slider 1836A.

The L-shaped arm 1832 comprises an actuating portion 1838 and a blocking portion 1839 terminating in a circular obstruction member 1840 sized to obstruct egress of a creature from the conduit 23 at the second end 16 of the elongate member 12 when positioned in front thereof. The cord 1834 is formed into a loop, which passes through a set of notches (analogous to notches 58 described in the context of retention arrangement 30) at the second end 16 of the elongate member 12. The looped cord 1834 has a first set of stops 1852 symmetrically disposed at an intermediate position at each side of the loop formed by the cord 1834 and a second set of stops 1854 disposed at or immediately adjacent the ends of the cord 1834. The portions of the cord 1834 between the first set of stops 1852 and the second set of stops 1854 are slidably received by receivers 1856 on the actuating portion 1838 of the L-shaped arm 1832, so that sliding movement of the cord 1834 relative to the L-shaped arm 1832 is constrained by the stops 1852, 1854.

The end of the actuating portion 1838 of the L-shaped arm 1832 that is remote from the blocking portion 1839 is pivotally mounted to the elongate member 12 by way of a bracket 1842. The actuator member 1836B has a guide channel 1870 defined therein, and the guide channel 1870 has a proximal end 1870A and a distal end 1870B, in each case relative to the elongate member 12, that is, the proximal end 1870A is closer to the outer surface of the elongate member 12 than is the distal end 1870B. The proximal end 1870A of the guide channel 1870 is closer to the first end 14 of the elongate member 12 and the distal end 1870B of the guide channel 1870 is closer to the second end 16 of the elongate member 12. The guide channel 1870 receives a guide post 1872 mounted on the actuating portion 1838 of the L-shaped arm 1832.

As can be seen with reference to FIGS. 18 and 19, by sliding the actuator slider 1836A (and hence the actuator member 1836B) along the length of the elongate member 12 toward the second end 16 thereof, the guide post 1872 is forced to travel along the guide channel 1870 toward the proximal end 1870A thereof, thereby forcing the L-shaped arm 1832 to pivot toward the elongate member 12. Conversely, by sliding the actuator slider 1836A (and hence the actuator member 1836B) along the length of the elongate member 12 away from the second end 16 thereof, the guide post 1872 is forced to travel along the guide channel 1870 toward the distal end 1870B thereof, thereby forcing the L-shaped arm 1832 to pivot away from the elongate member 12. Travel of the actuator slider 1836A along the elongate member 12 is limited by the travel of the guide post 1872 within the guide channel 1870, so that when the guide post 1872 is at the proximal end 1870A of the guide channel 1870, the location of the actuator slider 1836A (relative to the elongate member 12) defines a first position, and when the guide post 1872 is at the distal end 1870B of the guide channel 1870, the location of the actuator slider 1836A defines a second position.

In a preferred embodiment, a spring 1860 (shown with dashed lines) biases the L-shaped arm 1832 to pivot away from the elongate member 12 until further pivotal movement of the L-shaped arm 1832 is arrested by the looped cord 1834 (i.e. because the cord 1834 is looped through the notches in the elongate member 12 and the second set of stops 1854 prevents further relative sliding movement of the receivers 1856 and the cord 1834. A tab or similar projection 1890 may be provided on the actuating portion 1838 of the L-shaped arm 1832 for the spring 1860 to bear against. Preferably, at the point where further pivoting of the L-shaped arm 1832 away from the elongate member 12 is arrested by the cord 1834, the guide post 1872 will rest at the at the distal end 1870B of the guide channel 1870 so that the guide post 1872 and guide channel 1870 cooperate with the cord 1834, receivers 1856 and second set of stops 1854 in arresting further pivotal movement of the L-shaped arm 1832. Thus, the spring 1860 not only biases the L-shaped arm 1832 to pivot away from the elongate member 12, but also biases the actuator slider 1836A into the second position, as shown in FIG. 19. The position at which further pivotal movement of the L-shaped arm 1832 is arrested defines both the open position for the blocking member comprising the L-shaped arm 1832 as well as the retaining position for the retaining member comprising the cord 1834 (as will be explained in greater detail below), so that the spring 1860 has the effect of simultaneously biasing the blocking member comprising the L-shaped arm 1832 into the open position and biasing the retaining member comprising the cord 1834 into the retaining position. As will also be described further below, operation of the actuator (i.e. sliding the actuator slider 1836A and hence the actuator member 1836B toward the second end 16 of the elongate member 12) will overcome the biasing effect of the spring 1860 and thus move the blocking member comprising the L-shaped arm 1832 into the closed position and move the retaining member comprising the cord 1834 into the non-retaining position. A recess 1874 is provided at the second end 16 of the elongate member 12.

In operation, as shown in FIG. 18, a creature, in this particular instance an aquatic creature, namely minnow 80, is disposed inside the elongate member 12 adjacent the second end 16 thereof. The blocking member comprising the L-shaped arm 1832 is in the closed position, with the obstruction member 1840 inhibiting egress of the minnow 80 from the conduit 23 at the second end 16 of the elongate member 12, and the retaining member comprising the cord 1834 is in the non-retaining position with the loop formed by the cord 1834 positioned adjacent the walls of the conduit 23 and encircling the region of the minnow 80 to the immediate posterior of the minnow's head. The loop formed by the cord 1834 is maintained in this position by the pressure exerted by the receivers 1856 on the first set of stops 1852. The blocking member comprising the L-shaped arm 1832 may be maintained in the closed position, thereby maintaining the retaining member comprising the cord 1834 in the non-retaining position, by operation of the actuator (i.e. by application of pressure on the thumb-pad 1836C so that the actuator slider 1836A is maintained in the first position, as shown in FIG. 18).

Removing pressure from the thumb-pad 1836C allows the actuator slider 1836A to slide freely toward the second position, enabling the blocking member comprising the L-shaped arm 1832 to pivot, under urging from the spring 1860, away from the elongate member 12 and into the open position, as shown in FIG. 19. The pivotal movement of the L-shaped arm 1832 away from the elongate member 12 causes the receivers 1856 to slide along the cord 1834 until the receivers 1856 come in contact with the second set of stops 1854 on the cord 1834, after which continued pivotal movement of the L-shaped arm 1832, by way of the force exerted by the receivers 1856 on the second set of stops 1854, pulls the retaining member comprising the cord 1834 into the retaining position shown in FIG. 19. In the process of moving from the non-retaining position (FIG. 18) to the retaining position shown in FIG. 19, the retaining member comprising the cord 1834 captures and retains the minnow 80 (assuming that the minnow is suitably positioned so as to be encircled by the cord 1834 and the movement is made with sufficient speed), with the head of the minnow 80 exposed at the second end 16 of the elongate member 12. A hook (not shown in FIGS. 18 and 19) can then be installed in the minnow 80, and the actuator can then be operated (i.e. pressure can be applied to the thumb-pad 1836C so as to slide the actuator slider 1836A toward the second position) to move the blocking member comprising the L-shaped arm 1832 to a position intermediate the open position and the closed position. This provides enough slack in the loop formed by the cord 1834 to enable the minnow 80 to be withdrawn while still leaving the second end 16 of the elongate member 12 substantially unobstructed by the obstructing member 1840.

Optionally, a cap (not shown), similar to the cap 70 described in the context of FIG. 3, may be provided, which cap would be adapted to fit over the second end 16 of the elongate member 12, and also over the obstructing member 1840, when the blocking member comprising the L-shaped arm 1832 is in the closed position. This arrangement would prevent pivotal movement of the blocking member comprising the L-shaped arm 1832 away from the elongate member 12 under urging from the spring 1860 so as to retain the blocking member comprising the L-shaped arm 1832 in the closed position. This arrangement would also generally retain the actuator slider 1836A in the first position, since it cannot slide any significant distance unless the L-shaped arm 1832 pivots.

The exemplary embodiments of a retrieval device illustrated herein have shown the second end 16 of the elongate member 12 as being open, with retention of the creature within the conduit 23 being accomplished by a retention arrangement, such as retention arrangements 30, 930, 90, 100, 1230 and 1830. Alternatively, an elongate member forming part of a retrieval device according to an aspect of the present can have a closed second end. In such an embodiment, a creature could be retained within the conduit temporarily at the second end of the alternate elongate member, and then removed via the open first end by orienting the retrieval device so that the first end of the alternate elongate member is below the second end of the alternate elongate member, thereby allowing the creature to move under gravity to the first end of the elongate member.

In addition, while the exemplary embodiments of a retrieval device herein described have illustrated the capturing element 18 as taking the form of a porous scoop-shaped net, various other types of suitable capturing elements may also be used, without departing from the scope of the present invention. For example, a capturing element may comprise a scoop made from a non-porous material, so that water surrounding a targeted aquatic creature will also be captured by the capturing element. In addition, a capturing element forming part of a retrieval device according to an aspect of the present invention may have various shapes other than the scoop shape depicted herein, as long as the capturing element defines an interior volume, and has an entrance aperture opening into the interior volume and an exit aperture by which the interior volume is in fluid communication with the first end 14 of the elongate member 12 so as to permit passage of a suitably sized creature into the first end 14 of the elongate member 12. By way of non-limiting example, in an alternative embodiment the scoop 19 may be omitted entirely, and an element similar in shape to the funneling region 21 may be used as the capturing element.

It should also be noted that while the elongate member forming part of a retrieval device according to an aspect of the present invention has been shown as taking the form of a straight cylindrical tube, the elongate member may take other suitable shapes without departing from the scope of the present invention so long as the alternate elongate member has a first end and a second end and a conduit defined therethrough whereby the first end and the second end are in fluid communication so as to enable a suitably sized creature to travel along the conduit. For example, an elongate member for use in a retrieval device according to an aspect of the present invention may have a somewhat curved or arcuate shape, and may have an outer surface having a different geometric configuration than the inner surface that defines the conduit.

As shown herein, the spring 60 in the retention arrangement 30 is arranged so that a first leg of the spring 60 bears against the outer surface of the elongate member 12, and the second leg of the spring 60 bears upwards against the underside of the thumb-pad 36 so as to urge the L-shaped arm 32 away from the elongate member 12. In an alternate embodiment (not shown), the second leg of the spring can be bent over to bear downwards on the end of the L-shaped arm 32 that is received between the brackets 42, thereby urging the L-shaped arm 32 away from the elongate member 12 by way of lever action (using the pivotal attachment as a fulcrum). In addition, while the springs 60, 944 and 948, and 1860 are depicted as coil springs, it will be appreciated that leaf springs or other types of biasing members may also be used.

Reference has been made herein to creatures, including aquatic creatures such as minnows 80. Neither those particular creatures, nor any other creature, form part of the present invention, and any references to creatures in the claims are intended solely to define attributes of the invention and not to define any creature as a component of any embodiment of any aspect of the invention. In addition, while aspects of the invention may be particularly advantageous in respect of aquatic creatures, aspects of the present invention may also be advantageously used in respect of appropriate non-aquatic creatures. It should also be understood that certain retention arrangements may be unsuitable for certain creatures and/or certain purposes. For example, certain retention arrangements which are appropriate for fish being used as bait may not be appropriate for insects, due to a risk of excess pressure from a retaining member injuring or killing the insect. It will also be appreciated that embodiments of the present invention are useful in retrieving creatures of suitable size, and any particular embodiment of the present invention should not be used with an inappropriately sized creature (e.g. a creature that is too large to fit through the exit aperture 24). While minnows have been used as an exemplary aquatic creature for purposes of illustration, the term “creature” as used herein is not limited to minnows or even to aquatic creatures. The minnows 80 are merely exemplary creatures representative of creatures in association with which particular embodiments of aspects of the present invention may be used.

One or more currently preferred embodiments have been described by way of example. It will be apparent to persons skilled in the art that a number of variations and modifications can be made without departing from the scope of the invention as defined in the claims.

What is claimed is:

1. A retrieval device for retrieving creatures, comprising:
a tube having a first end and a second end, the first end of the tube being in fluid communication with the second end of the tube; and
a scoop secured at the first end of the tube, the scoop defining a hollow region and having a mouth permitting entry of a suitably sized creature into the hollow region, the scoop further having an opening permitting passage of the suitably sized creature from the hollow region into the first end of the tube;
wherein the scoop is configured so that when the suitably sized creature is within the hollow region and the retrieval device is oriented with the first end of the tube above the second end of the tube with the mouth facing generally upward, the scoop guides the creature to move under gravity from the hollow region into the first end of the tube and along the tube to the second end of the tube.

2. The retrieval device of claim 1, wherein the second end of the tube is adapted to permit egress of the creature from the tube.

3. The retrieval device of claim 1, wherein the scoop comprises a net.

4. The retrieval device of claim 2, further comprising a retention arrangement disposed at the second end of the tube.

5. The retrieval device of claim 4, wherein the retention arrangement comprises:
a blocking member movably mounted to the tube so as to be movable between an open position enabling egress of the creature from the second end of the tube and a closed position inhibiting egress of the creature from the second end of the tube;
a retaining member movable between a retaining position for retaining the creature adjacent the second end of the tube and a non-retaining position permitting movement of the creature along the tube; and
an actuator operable to move the blocking member between the open position and the closed position while moving the retaining member between the retaining position and the non-retaining position, so that when the blocking member is in the open position the retaining member is in the retaining position, and when the blocking member is in the closed position the retaining member is in the non-retaining position.

6. The retrieval device of claim 5, wherein the blocking member is biased into the open position and the retaining member is biased into the retaining position and operation of the actuator moves the blocking member into the closed position and moves the retaining member into the non-retaining position.

7. The retrieval device of claim 6, wherein the retention arrangement further comprises a locking mechanism for locking the blocking member in the closed position.

8. The retrieval device of claim 5, wherein the blocking member is biased into the closed position and the retaining member is biased into the non-retaining position and operation of the actuator moves the blocking member into the open position and moves the retaining member into the retaining position.

9. The retrieval device of claim 4, wherein the retention arrangement comprises a removable cap adapted to fit over the second end of the tube in substantially fluid sealing engagement therewith.

10. The retrieval device of claim 4, wherein the retention arrangement comprises a bag removably secured to the second end of the tube in substantially fluid sealing engagement therewith so that the second end of the tube opens into an interior of the bag.

11. The retrieval device of claim 4, wherein the retention arrangement comprises:
a plurality of retaining members movable between respective retaining positions wherein the retaining members project inwardly into the tube for retaining the creature between the retaining members and adjacent the second end of the tube, and respective non-retaining positions so that movement of the creature along the tube is permitted, the retaining members being biased into the respective non-retaining positions.

12. The retrieval device of claim 11, further comprising:
an actuator operable to move the retaining members between the respective retaining positions and the respective non-retaining positions.

13. A retrieval device for retrieving creatures, comprising:
an elongate member having a first end and a second end and a conduit defined therethrough so that the first end and the second end are in fluid communication;
a capturing element secured to the elongate member at the first end thereof the capturing element defining an interior volume, the capturing element having an entrance aperture opening into the interior volume, the capturing element further having an exit aperture by which the interior volume is in fluid communication with the first end of the elongate member;
wherein the capturing element is configured so that when a suitably sized creature is within the interior volume and the retrieval device is oriented with the first end of the elongate member above the second end of the elongate member with the entrance aperture facing generally upward, the capturing element guides the creature to move under gravity from the interior volume through the exit aperture into the first end of the elongate member and along the conduit to the second end of the elongate member.

14. The retrieval device of claim 13, wherein the capturing element comprises a porous, scoop-shaped net.

15. The retrieval device of claim 13, wherein the second end of the elongate member is adapted to permit egress of the creature from the conduit.

16. The retrieval device of claim 15, further comprising a retention arrangement disposed at the second end of the elongate member.

17. The retrieval device of claim 16, wherein the retention arrangement comprises:
a blocking member movably mounted to the elongate member so as to be movable between an open position enabling egress of the creature from the conduit via the second end of the elongate member and a closed position inhibiting egress of the creature from the conduit via the second end of the elongate member;
a retaining member movable between a retaining position for retaining the creature in the conduit adjacent the second end of the elongate member and a non-retaining position permitting movement of the creature along the conduit; and
an actuator operable to move the blocking member between the open position and the closed position while moving the retaining member between the retaining position and the non-retaining position, so that when the blocking member is in the open position the retaining member is in the retaining position, and when the blocking member is in the closed position the retaining member is in the non-retaining position.

18. The retrieval device of claim 17, wherein the blocking member is biased into the open position and the retaining member is biased into the retaining position and operation of the actuator moves the blocking member into the closed position and moves the retaining member into the non-retaining position.

19. The retrieval device of claim 18, wherein the retention arrangement further comprises a locking mechanism for locking the blocking member in the closed position.

20. The retrieval device of claim 18, wherein the blocking member is biased into the closed position and the retaining member is biased into the non-retaining position and operation of the actuator moves the blocking member into the open position and moves the retaining member into the retaining position.

21. The retrieval device of claim 16, wherein the retention arrangement comprises a removable cap adapted to fit over the second end of the elongate member in substantially fluid sealing engagement therewith.

22. The retrieval device of claim 16, wherein the retention arrangement comprises a bag removably secured to the second end of the elongate member in substantially fluid sealing engagement therewith so that the second end of the elongate member opens into an interior of the bag.

23. The retrieval device of claim 16, wherein the retention arrangement comprises:
a plurality of retaining members movable between respective retaining positions wherein the retaining members project through the elongate member and inwardly into the conduit for retaining the creature between the retaining members and adjacent the second end of the elongate member, and respective non-retaining positions so that movement of the creature along the conduit is permitted, the retaining members being biased into the respective non-retaining positions.

24. The retrieval device of claim 16, further comprising:
an actuator operable to move the retaining members between the respective retaining positions and the respective non-retaining positions.
